(19) United States
(12) Patent Application Publication
(10) Pub. No.: US 2020/0202432 A1
(43) Pub. Date: Jun. 25, 2020

(54) SELF-GOVERNING TRADE REQUEST MANAGEMENT SYSTEMS

(71) Applicant: David Sun, Vancouver, WA (US)

(72) Inventor: David Sun, Vancouver, WA (US)

(21) Appl. No.: 16/226,310

(22) Filed: Dec. 19, 2018

(51) Int. Cl. G06Q 40/04; G06Q 20/40; G06F 3/0482

(52) U.S. Cl. CPC G06Q 40/04; G06F 3/0482; G06Q 20/405

(57) ABSTRACT

A method, system, apparatus, and/or device for an individual to self-govern trade requests. The method, system, apparatus, and/or device may include: generating a trade rules account for a user based on trade rules account information received from an input device; defining a set of trade rules for one or more trade requests generated by the input device; receiving a user input indicating a trade rule of the set of trade rules associated with the trade rule account; defining a period of time that the trade rule is enforced on the one or more trade requests; receiving a trade request; determining whether the trade request follows the trade rule; and in response to the trade request complying with the trade rule, sending a message to a second processing device that includes details of the trade request.

### BACKGROUND

Traders of various tradable instruments (such as stocks, bonds, futures, forex, options, cryptocurrency, and so forth) may place orders through trading platforms. Within a trading platform, a trader may be given limited buying power. For example, the trading power limit may be the maximum value of a trade instrument that may be purchased or sold at any one time. A trader's trading power limits are sometimes referred to as risk limits or position limits. Trading power limits are typically set by a trader's brokerage firm based on the amount of money the trader has in an associated brokerage account or by the risk manager for the trader's account based on the risk manager's assessment of the risk involved in honoring the trader's position in light of the trader's risk profile. The trading power limits are caps on the ability of the trader to execute orders and the limits are typically fixed and remain static over reasonably long periods of time.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding.

FIG. 1 illustrates a method to self-govern the trade requests for tradable instruments, according to an embodiment.

FIG. 2A illustrates a graphical user interface (GUI) for an individual to monitor tradable instruments and/or generate trade request, according to an embodiment.

FIG. 2B illustrates another GUI for an individual to monitor tradable instruments and/or generate trade request, according to an embodiment.

FIG. 3 illustrates a GUI for an individual to set trade rules to approve or deny a trade request by a user, according to an embodiment.

### DETAILED DESCRIPTION

The disclosed self-governing trade request management systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of self-governing trade request management system examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Individuals of various tradable instruments may place orders through trading platforms. Conventionally, individuals may perform trades through a brokerage firm. The brokerage firm may places limits on the trading power of an individual to avoid impulsive or reckless trading. The conventional brokerage firm may limit a dollar amount the individual may buy or sell of a given tradable instrument or restrict the individual from trading certain instruments, or entirely after a certain amount of loss. Additionally, the brokerage firm may assign a supervisor, such as a risk manager, to review the individual's trades prior to executing the trades on behalf of the individual. Conventional trading firms and trading floors also have risk managers oversee the actions of their traders, to prevent traders from overstepping their daily loss limits or acting recklessly or in a rogue manner.

In the case of an individual with a relatively small amount of wealth to invest or the individual that trades as a hobby or side business, the individual may execute the trading of tradable instruments on a trading platform that automatically executes the individual's trades without providing any supervision or oversight to aid the individual in avoiding impulsive and/or emotional trading. Conventionally, the individual is left to self-govern his/her trades. However, individuals left to self-govern their trades often lose self control during trading and act emotionally in the heat of the market, breaking their own trade rules and plans. For example, when the one or more of the individual's trades begin to decrease in value such that the individual begins losing money, the individual may begin to lose confidence in his or her tradable instruments or trading ability, panic, double down on the losing bet, or revenge trade after a loss out of anger (also referred to as being on tilt) and the individual may begin to make impulsive and/or emotional trades. Alternatively, when a tradable instrument not owned by the individual begins to perform well, the individual may begin to purchase the tradable instrument at an inflated cost because the individual may fear of missing out on a great opportunity. The lack of supervision or oversight for an individual may lead to impulsive and emotional trading that results in big losses and blown accounts, because of a single session of emotional trading and lack of self-discipline, much like a gambling addict losing self-control in a casino and betting recklessly and past a sensible loss limit.

Implementations of the disclosure address the above-mentioned deficiencies and other deficiencies by providing a method, a system, a device, and/or an apparatus for an individual to self-supervise the trading of tradable instruments to avoid emotional and impulsive trading. The method, the system, the device, and/or the apparatus may provide a platform for the individual to define rules to describe when and how the individual may send a trade request to a brokerage platform to execute a trade. The platform may include a graphical user interface for a user to select and customize risk rules, psychological rules, physiological rules, and so forth that the individual may use to self-supervise potential trades by the individual prior to the individual executing the trades. The platform may enforce these rules for a set period of time, allowing or disallowing trade requests to be created, depending on whether or not it adheres to the various rules the trader has set for himself or herself.

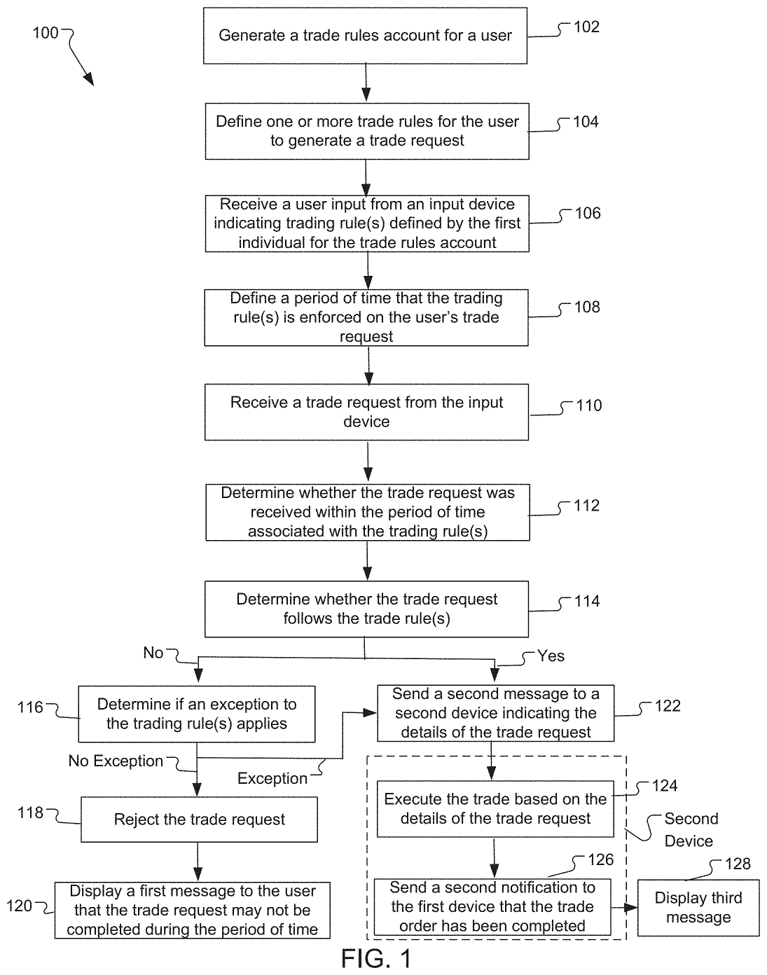

FIG. 1 illustrates a method 100 to self-govern the trade requests for tradable instruments, according to an embodiment. In one embodiment, the method 100 may be executed by one or more systems, devices, and/or apparatuses. The one or more systems, devices, and/or apparatuses may include a data storage device (such as a non-transitory data storage medium) that stores instructions that when executed by a processing device causes the processing device to perform the method 100 and/or any method disclosed herein.

The method 100 may include generating a trade rules account for a first individual (Block 102). In one embodiment, a display may display a graphical user interface (GUI) where the first individual may enter trading account information. The trading account information may include a name, an email address, a banking number, a trading account number, trading account information for another system, a password, configuration information for the GUI, and so forth. The method 100 may include defining one or more trade rules for the first individual to follow when generating trade request a trade order (Block 104). In one example, the trade rules may be predefined. In another example, the trade rules may be user generated using an input device via a GUI executing on a processing device. In another example, an initial set of trade rules may be predefined and the user may set variables of the trade rules via the GUI. In another example, the trade rule(s) may include risk rules, psychological rules, physiological rules, and so forth.

In one example, the risk rules may include a session filter rule to limit or reduce a max size or restrict new positions or close orders during X time or X amount of volume. As referred to herein, “X” may represent a numeric variable (such as 1, 2, 3, 4, and so forth) that may be defined by an individual via a graphical user interface (GUI) or by a system or platform. The session filter rule may aid a trader in preventing the trader from oversizing positions in lower liquidity environments for example the Asian session and/or potentially high volatility time frames, such as certain opening timeframes or closing timeframes of a trading session. In another example, the risk rules may include a trend rule defining how much to reduce max size to or limit the number of open orders, if a potential trade position or trade request is against a trend indicator (such as an X hour moving averages crosses trend). The trend rule may aid a trader in going with a market trend, and reducing his potential exposure when going against the trend, such as a positive trend in the price of gold or soybeans.

In one example, the risk rules may include a correlation guard rule that may define a maximum VaR (value at risk) percentage of their portfolio an individual can have open in a directionally correlated asset class or currency, and may reduce the max size or restrict new correlated orders if a directional risk of the correlated basket of assets exceeds a certain preset amount. The correlation guard rule may prevent a trader from overexposure to a particular directional bet with highly correlated assets. In another example, the risk rule may include a stop widen guard rule where if a trader widens his stop loss on a particular position to an amount larger than his preset VaR, the platform may close a partial portion of the position to match the max value at risk (VaR) per trade setting or a count it as part of another potential trade's max VaR within a total daily VaR limit. The stop widen guard rule may discourage widening stop losses to take on extra unplanned risk per trade. In another example, the risk rules may include an event guard rule to reduce or hedge open positions and restrict new positions going into and/or during predetermined market events, for example a trade meeting, fed meeting, economic numbers, election, earnings, and so forth. The event guard rule may protect positions and traders from highly volatile events with unknown outcomes.

In one example, the risk rules may include a max daily loss rule for setting a maximum loss amount of a trading portfolio. The loss amount may be a percentage loss amount, a dollar loss amount, a R-multiple (Risk/Reward Ratio Multiple) loss amount of the trading portfolio, or a number of losing trades in a row. The max daily loss rule may limit daily risk to a trading portfolio. In another example, the risk rules may include a max VaR rule to define a maximum amount at risk (also referred to as a stop loss+ slippage) per trade or for an entire portfolio. The max VaR rule may prevent oversizing positions and taking on excessive risk per position. In another example, the risk rules may include a max order size rule to define a maximum notional amount per trade. The max order size rule may limit a maximum amount of money at risk per trade.

In another example, the risk rules may include a max orders open rule to define a maximum amount of orders open in a day or in total for the trading portfolio. The max orders open rule may prevent excessive positions by a trader that may be hard to manage. In another example, the risk rules may include a max total orders rule to define a maximum amount of orders opened and closed over a defined period of time, such as a day, a week or X amount of time. The max total orders rule may prevent overtrading by an individual. In another example, the risk rules may include a max overnight or weekend VaR rule to define a maximum notional amount or percentage value at risk overnight or over the weekend. The max overnight or weekend VaR rule may prevent a trader from overexposure to events or market moves overnight and/or during weekend market closures, which are time periods when the trader may not be able to adjust or stop out of open positions until the market reopens.

In another example, the risk rules may include a preset probability sizes and trade setup quality rule to define preset order sizes that pertains to the judged success probability of the trade setup. The trade setup quality may be judged on whatever metric the trader desires, for example if the trader judges the current price movement and chart patterns to show a certain probability of success for their trade idea, this judgement of trade setup quality may be categorized with a system of labels. The system labels may include low quality, medium quality, high quality, very high quality, and so forth. The trade setup quality rule may be a rule to open a position with the sizing of the position automatically done according to VaR amounts (amount of money at risk in the size of stop loss) that correspond to a defined probability of success associated with the quality of the setup. In one embodiment, a trader may define the probability of success of a trade setup as “medium quality” which allows a preset max amount of VaR for example 0.1% of funds VaR in that position, a high quality trade setup that allows a preset max 0.5% VaR, and a very high quality setup that allows a preset max of 1% VaR. The trade setup quality rule may encourage a trader to think and act probabilistically when judging market opportunities, and precisely control their risk per trade appropriate to the judged quality of the setup.

In another example, the risk rules may include a volatility sizing rule to define a preset maximum order size that may adjust according to volatility indicators. The volatility sizing rule may prevent inappropriate sizing during high or low volatility market conditions. In another example, the risk rules may include an adding to winners rule to restrict a trader to opening new same position same direction trades only if the original trades have stop-loss set to breakeven or according to a total preset max VaR amount per position, or if the original trades are in profit of more than X % or a certain amount of pips (pips is a fundamental unit of measure used when trading currencies) or a max number of new same positions settings, to enable large positions without oversized exposure or unplanned VaR. For example, a trader who has a position of long gold futures 1 lot may only increase the position by another 1 lot if the previous position is 5 points in profit and stop losses are moved to break even or a certain max VaR amount, so every new same position same direction order added won't surpass a preset VaR limit for the entire position, the rule may automatically move the stop loss of earlier orders to breakeven or X to preserve a certain max VaR amount.

In another example, the risk rules may include a smart exits rule defining an indicator trigger for exiting an open order. The indicator trigger may be customized for individual open orders. In one example, the indicator trigger may be a certain moving average that crosses another moving average. In another example, the indicator trigger may be the trade being open for a defined period of time and a trailing stop executed afterwards. In another example, the indicator trigger may be X number of high or low clusters of market orders being filled in the orderbooks. In another example, the indicator trigger may be a trade hitting a high volume node in a volume profile chart. In another example, the risk rules may include a smart stop rule where advanced dynamic stop losses are applied to trades with different smart stops set for portions of a position. In one example, the stops may be based on other indicators, such as time, volatility measured in Bollinger bands width, or Keltner channels becoming narrower than the Bollinger Bands, a volume or price surge, trend lines, moving average (MA) crosses, patterns, average true range (ATR), Heikinashi candle trend flips, indicator flips (relative strength index crossing a defined number or moving average convergence divergence flips), a Ichimoku cloud breach, and so forth. In another example, the stops may be dynamic stops where a trader does not need to watch a display for optimal stop out of his positions. In another example, the stops may be partially executed by portion, based on indicators for example a short SPX position, close 50% when volatility decreases (e.g. a bbands width thinner than X), close other 50% if price rises above X and stays there for the next X number of X minute candles.

In another example, the risk rules may include a hedge all positions rule to open hedging positions (e.g. long or short same pairs or positions with preset hedges on other tradable instruments). In another example, the risk rules may include a break-even stop loss rule to move a stop loss to breakeven on all profitable positions over X % or X pips. The break-even stop loss rule may eliminate downside risk for already profitable positions. In another example, the risk rules may include a multiple scenario entry rule to open a trade and/or cancel other trades if a trigger happens. For example, in an uncertain market environment, the multiple scenario entry rule may open a trade if a particular event or price action occurs in the market. In another example, the risk rules may include a VaR sizing rule to automatically size an order according to the size of stop loss to adhere to the maximum VaR settings.

In another example, the risk rules may include an add to winners rule that may only allow the user, via a GUI, to add more orders on to a profitable position if original position's stop loss was set to break even or at a level where the max VaR did not exceed the preset limit, so a user could take higher sized positions without excessive VaR exposure. In another example, the risk rules may include an event guard rule that may restrict a user from trading, reduce max order sizes, and/or readjust open position sizes as the market enters a time period where a predetermined event will occur, such as an FOMC or earnings call event. In another example, the risk rules may include a max overnight or overweekend rule that may reduce max order sizes and max open positions as the markets close going into the weekend, to prevent excessive portfolio exposure to events that are outside of the traders control while the markets are closed.

In one example, the psychological rules may include a profitable streak day filter rule to reduce a max order size or restrict trading for a defined period of time after certain X % of total realized profit or X numbers of profitable trades. The profitable streak day filter rule may prevent a trader with multiple wins from becoming overconfident and subsequently betting recklessly or having a optimistic bias towards his next trades (positive tilt). In another example, the psychological rules may include a profitable streak profit keeper rule to restrict or reduce a max number of new trades or trading sizes after a certain amount of profitable trades or profit amount have been made in a defined period of time (such as X day or X weeks), so that a trader going forward may only take new positions using VaR of the profits from the previous profitable trades for X amount of time. For example, if a trader has made 30% profit in a week, the next week the trader can only have on a maximum of total 20% VaR on their new trades, so in case of a poor trading week the trader will only have risked the 20% of the 30% profit he made in the previous week. The win streak profit keeper rule may prevent a trader from losing all or a portion of their profits from their previous profitable trades.

In one example, the psychological rules may include a losers average rule to only allow a trader to average down a losing position X times with max X size and automatically stop out a second or subsequently averaged position or X positions after X % loss. The loser's average rule may prevent oversized trades, overexposure to a losing trade, and Martingale-style disaster trades. In another example, the psychological rules may include a chase or fear of missing out (FOMO) guard rule to restrict or reduce a maximum order size of new long orders if a momentum indicator (for example X hr RSI, MACD, or ADX is over X amount) shows overbought conditions for example RSI over 80. In another example, the psychological rules may include a panic sell guard rule to restrict new short orders or sell orders, or reduce amount of the max order size of new short orders if a momentum or trend indicator (for example X hr RSI, MACD, ADX and so forth) shows oversold conditions, for example a 1 hour RSI under 25. In another example, the psychological rules may include a revenge trading guard rule to reduce max order sizes or restrict trading for X amount of time for a trader to cool off emotionally if a net loss, or defined amount of loss occurs over X amount of days, X trades in a day, or X trades in a row occurs. The revenge trading guard rule may prevent revenge trading, tilt trading, and/or emotional trading in cases where the trader loses money and enters trades emotionally in an attempt to “get it back”. In another example, the psychological rules may include an emotion guard rule to restrict opening a new trade position for a defined threshold amount of time after a profitable or losing trade has occurred. The emotion guard rule may reduce or eliminate emotional behavior arising from a previous profitable or losing trade. In another example, the psychological rules may include a patience guard rule that may restrict a trader from opening new positions until a particular market event or indicator as occurred. For example the patience guard rule may restrict a trader from taking a position in gold futures until an indicator of volatility has surpassed a defined number.

In one example, the physiological rules may include a fat finger guard rule to disallow or prevent a trade with an uncharacteristic massive size or mispricing of an order that is unintended or far off the current market prices. The fat finger rule may prevent accident entry of an order when an individual unintentionally performs a trade. For example, if the individual is bumped, mistypes, unintentionally clicks, or otherwise accidentally performs a trade, the fat finger guard rule will disallow or prevent the trade. In another example, the physiological rules may include a trader nap rule to restrict a trade from being executed when trading has occurred for at least a threshold period of time. In one example, if the individual has been trading for a threshold period of time to the point that they are tired or weary, the rule may restrict the individual from executing any further trades until a second threshold period of time has passed.

In one example, the trader may set a defined period or time to restrict themself from trading if there is unfavorable action across the market. The trader nap rule may prevent overtrading and/or avoiding low volume trading environments or choppy trading environments. In another embodiment, the processing device may receive signals from a wearable biometric device, such as a smartwatch, and process the signals as a part of a physiological rules setting. For example, if the user's heartbeat is unusually fast, over X bpm, the self-governing trade request management system may display a warning sign that the trader is getting too emotional, or reduce the max order sizes until the user's heartbeat bpm lowers back down to a stable state. In another example, the physiological rules may include a biometric signals rule. The biometrics signals rule may include a biometric sensor (such as a sensor integrated into a wearable device) that may detect a biometric signal of a user. The processing device may receive the biometric signal from the biometric sensor and restrict a user from trading or display a warning on the GUI if the biometric signal surpasses a preset number or level. In one example, when the biometric signal surpasses the preset number or level the GUI, the processing device, and/or the wearable device may alert the user of the biometric signal and prevent the user from performing emotional trading.

The method 100 may include receiving user input from an input device coupled to a first device indicating one or more trade rules defined by the first individual when performing a trade (Block 106). In one example, the input device may be a mouse, a keyboard, a touchscreen, a touch sensor, a trackpad, and so forth that may send the first device data from a user. In one example, the first device may be a device associated with an individual performing trades. In one embodiment, the user may use the input device to define a single trade rule. In another embodiment, the user may use the input device to define multiple trade rules. For example, the user may define a first trade rule and a second trade rule that are different. The first trade rule may be a first type of trade rule and the second trade rule may be a second type of trade rule. The multiple trade rules may be different types of trade rules. The types of trade rules may include risk rules, psychological rules, physiological rules, and so forth. The trade rules may also be part of a rule profile, as discussed below. The method 100 may include defining a period of time that the trade rule is enforced on the first individual's trade (Block 108). In one example, the period of time may be set to attempt to alter or reinforce a specific behavioral habit as related to an individual's trading habit. For example, the period of time may reinforce the trading habit of not selling a stock when the stock takes a temporary loss. In one example, the period of time of enforcing the trade rule might provide a process of ensuring the trader stays disciplined to adhere to their trade rule, by not allowing them to break or deviate from his trade rules prematurely until the period of time has expired.

The method 100 may include receiving a trade request from an input device at the first device associated with the first individual (Block 110). In one example, a trade request is a request entered by the first individual to request the first device to send a trade request to a second device (such as a device of a brokerage platform) to execute a trade. In this example, prior to the first device sending the trade order to the second device, the first device will determine whether the request conforms to the trade rules and send a trade order to the second device when the trade request conforms to the trade rules or reject the trade request if it does not conform to the trade rules, as discussed below. When the first device rejects the trade request, a trade order will not be sent to the second device, and the second device will not know what actions or requests have been made to the first device. In on embodiment, the second device may only receive raw unaltered orders to protect a trader's privacy. The configuration of the trade rules occur at the first device and are not provided or accessible to second device.

The method 100 may include the first processing device determining whether the trade request was received within the period of time associated with the trade rules (Block 112). The method 100 may include the first processing device determining whether the trade request follows the one or more trade rules (Block 114).

In one embodiment, when the trade request does not follow or is non-compliant with one or more trade rules, the method 100 may include the first processing device determining if an exception to the trade rule applies (Block 116). The method 100 may include the first processing device rejecting the trade request when an exception does not apply (Block 118). The method 100 may include the first processing device displaying, via a display device, a first message to a user that the trade may not be completed during the period of time when the exception does not apply (Block 120).

In another embodiment, when the trade request follows or is compliant with one or more trade rules or the exception applies, the method 100 may include the first processing device sending a message to a second device indicating the details of the trade request (Block 122). The method 100 may include executing, on a second device, the trade based on the details of the trade request (Block 124). The method 100 may include sending a second message from the second device to the first device that the trade has been completed (Block 126). The second device may be a processing device or a server providing trade broker services. For example, the second device may be a server executing a software platform to receive trade requests from individual traders and execute the requests on a stock exchange. In another example, the second device may be a brokerage firm's trade execution server, in which the firm's clients' orders are sent here to be executed on various exchanges. The method 100 may include displaying the second message on the display device coupled to the first processing device (Block 128). In one embodiment, the input device and the display device may be coupled to the first processing device. In another embodiment, the first processing device and the second processing device may be communicatively coupled together. In another embodiment, the first processing device may receive multiple trades at the same time and perform the method 100 for each trade. In another embodiment, the first processing device may receive different trades a different points in time and may perform the method 100 for each trade.

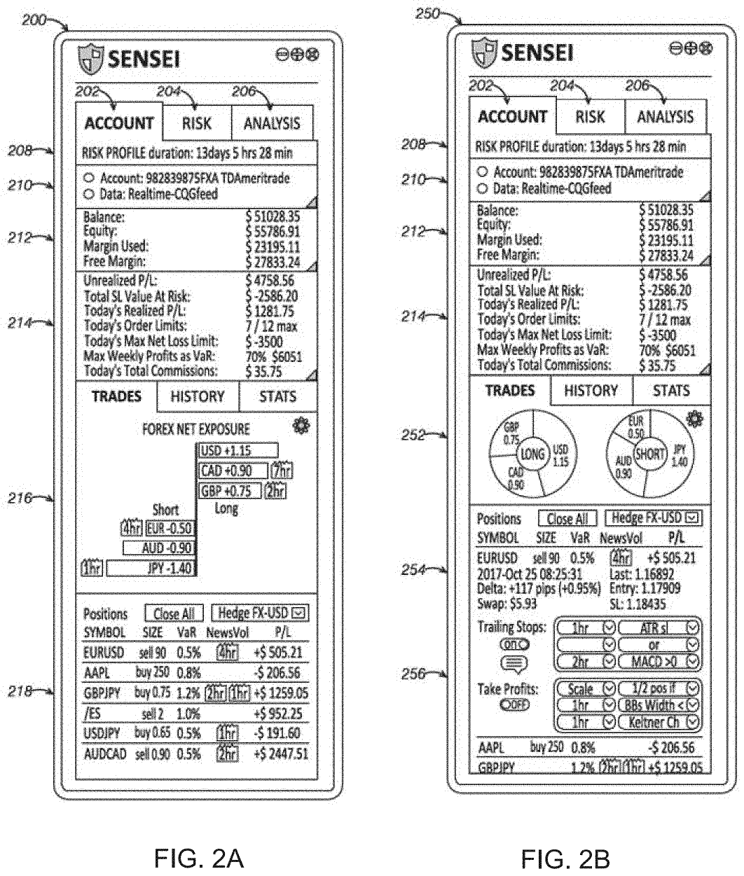

FIG. 2A illustrates a graphical user interface (GUI) 200 for an individual to monitor tradable instruments and/or generate a trade request, according to an embodiment. The GUI 200 may include an account tab 202, a risk tab 204, and an analysis tab 206. When selected by an input device, the account tab 202 may display an account interface for an individual to review their trading portfolio of their trades, stocks, bonds, and other tradable instruments. When selected by an input device, the risk tab 204 may display a risk interface for an individual to review and set trade rules to determine whether to send trade requests to a brokerage service or platform, as further discussed below. When selected by an input device, the analysis tab 206 may display an analysis interface for an individual to analyze their trading portfolio, trading history, performance, and/or information about their tradable instruments.

In one embodiment, the account tab 202 may display a risk profile duration indicator 208. When a user generates a set of rules for trade requests using the risk tab 204, a time duration may be set for the set of rules to be enforced. The risk profile duration indicator 208 may indicate an amount of time remaining for the set of rules to be enforced for any trade request the self-governing trade request management system may send to another device or system, such as a brokerage platform that exercise the trade request as a trade order.

In another embodiment, the account tab 202 may display an account information indicator 210 to show account information associated with a user. For example, the user may have a brokerage service account that is linked to the self-governing trade request management system. The account information indicator 210 may display the brokerage service account information, such as an account number, the type of account, the name of the brokerage service provider, and so forth. The account information indicator 210 may display information about a configuration of the brokerage service account, such as a type of feed from the brokerage service (e.g. a live feed or a periodic feed), the format of the brokerage account information, and so forth.

In another embodiment, the account tab 202 may display a financial information indicator 212 for a financial account associated with a user. The financial information indicator 212 may provide balance information, equity information, margin used information, free margin information, and so forth. The balance information may indicate a total value of a user's account. The equity information may indicate a sum of the margin put up for the trade from the user's account in addition to any unused account balance. The margin used may indicate the amount of funds in operation, including withdrawals and new positions, and the free margin may indicate an amount of funds not in operation.

In another embodiment, the account tab 202 may display a trade status indicator 214 for a trading portfolio associated with a user. The trade status indicator 214 may indicate unrealized profit/loss (P/L) information, total stop loss (SL) value-at-risk information, realized P/L information for the current day, order limit information for the current day, maximum net loss limit information for the current day, maximum weekly profits as a value of risk (VaR) information for the current week, total commission information for the current day, and so forth.

In another embodiment, the account tab 202 may display a trade exposure indicator 216 for a trading portfolio associated with a user. The trade exposure indicator 216 may provide an exposure indicator of one or more tradable instruments in the user's portfolio. The trade exposure indicator 216 may indicate the risk that a user's equities, assets, liabilities, income, or other tradable instruments may change in value as a result of exchange rate changes. The trade exposure indicator 216 may also indicate which of the user's positions are long and which of the user's positions are short. The trade exposure indicator 216 may also indicate the current amount of exposure to various assets, for example currencies, stocks, or cryptocurrencies, and so forth.

In another embodiment, the account tab 202 may display a position indicator 218 for a trading portfolio associated with a user. The position indicator 218 may indicate the current open positions in a trader's account, and the various metrics and stats about the positions such as size, VaR, how many hours until a preannounced volatile news event, and profit/loss. In one embodiment, the account tab 202 may have sub-tabs including a trades sub-tab to display current information about user's trade account, a history sub-tab to display historical trade information for previous trades by the user, and a statistics sub-tab to display statistical information about the user's trade portfolio and trading performance. In one embodiment, the trade exposure indicator 216 and the position indicator 218 may be displayed when the trades sub-tab is selected by the user via the user interface.

FIG. 2B illustrates a graphical user interface (GUI) 250 for an individual to monitor tradable instruments and/or generate trade request, according to an embodiment. Some of the features in FIG. 2B are the same or similar to some of the features in FIG. 2A as noted by same reference numbers, unless expressly described otherwise. In one embodiment, the GUI 250 may include a trade exposure indicator 252 for a trading portfolio associated with a user. In one example, the trade exposure indicator 216 may be illustrated by bar graphs, as shown in FIG. 2A. In another example, the trade exposure indicator 252 may be illustrated by circular graphs or pie charts, as shown in FIG. 2B. The types of graphs or graphical objects used to display the trade exposure information are not intended to be limiting. For example, the graphs or graphical objects may include histograms, scatter plots, line graphs, pie charts, bar charts, and so forth. Similar to the trade exposure indicator 216, the trade exposure indicator 252 may provide an exposure indicating of one or more tradable instruments in the user's portfolio and which of the user's positions are long and which of the user's positions are short.

In one embodiment, the GUI 250 may include a position indicator 254 is for a trading portfolio associated with a user. In one example, the position indicator 254 for a trading portfolio associated with a user. The position indicator 254 may indicate a position of futures contracts, and metrics like the associated position size, metrics, entry information, stop loss location, time and date, delta, VaR, time of volatile news, and so forth. In another example, the position indicator 254 may include a trade request configuration sub-interface 256. The trade request configuration sub-interface 256 may provide a sub-interface for a user to select a position within their trade portfolio and graphical control elements for the user to select when or how to set a trailing stop for a position and when and how to take the profits from a position. The graphical control elements of the trade request configuration sub-interface 256 may allow a user to select an amount of time before they execute trailing stops or take profits, or scale out of the position with multiple exits triggered by different conditions, and so forth.

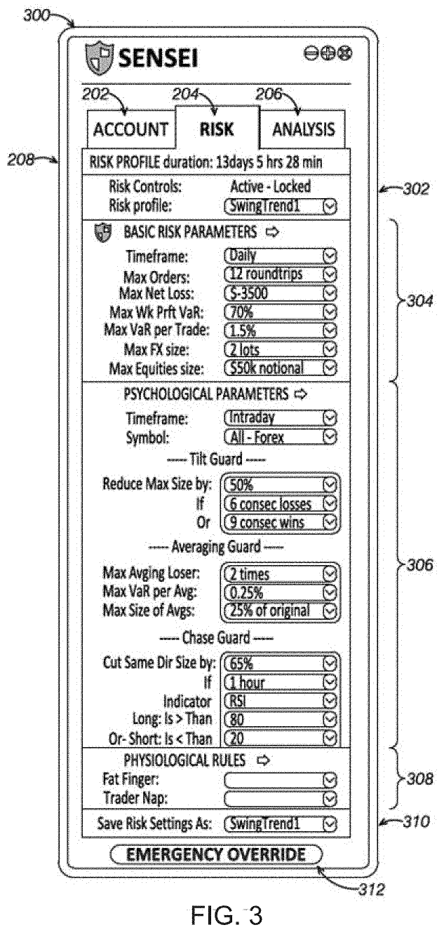

FIG. 3 illustrates a graphical user interface (GUI) 300 for an individual to set trade rules to approve or deny or readjust a trade request by the individual, according to an embodiment. Some of the features in FIG. 3 are the same or similar to some of the features in FIGS. 2A and 2B as noted by same reference numbers, unless expressly described otherwise. For example, the GUI 300 may include the account tab 202, the risk tab 204, and the analysis tab 206.

When selected by an input device, the risk tab 204 may display a risk interface for an individual to review and set trade rules for sending trade requests to a brokerage service or platform. In one embodiment, the risk tab 204 may display a risk profile duration indicator 208. When a user generates a set of rules for trade requests using the risk tab 204, a time duration may be set for the set of rules to be enforced and a time duration before the rules may be reset or changed. The risk profile duration indicator 208 may indicate an amount of time remaining for the set of rules to be enforced for any trade request the self-governing trade request management system may send to another device or system, such as a brokerage platform that exercises the trade requests as a trade order.

In one embodiment, the risk rules or settings may be set to function for a specific amount of time, such as a specific number of minutes, hours, days, weeks, or months. In one example, the amount of time may be set for an individual rule. In another example, the amount of time may be set for a group of rules or settings. In one embodiment, the user may manually set the time duration for the individual rules or setting and/or the group of rules or settings. In another example, the self-governing trade request management system may automatically set the time duration for the individual rule or setting and/or the group of rules or settings.

In another embodiment, the amount of time set for the risk profile duration indicator 208 may allow a user to lock in a risk profile to be applied to any trade requests for the defined amount of time. The locking feature may prevent self-sabotaging or undisciplined emotional behavior by a trader by forcing the trader to send trade requests to a brokerage firm or service that conform to the risk profile.

In another embodiment, the risk tab 204 may include an emergency override button 312 for an individual to override the remaining amount of time left for the risk profile duration indicator 208 and send a trade request to a brokerage firm or service that conflicts with one or more or the rules set in the risk profile 302. The override may include allowing a user to modify or change the trade rules, temporarily overriding the trade rules for a period of time, and so forth. In one example, in an emergency situation or rare market opportunity, a user may set an override penalty for a penalty instruction to be executed when the user prematurely unlocks the risk profile. The penalty may be set to discourage the user from irrationally or impulsively unlocking the risk profile 302 by causing the user to perform an undesirable or self-deterring activity in order to unlock the risk profile 302. In one example, the penalty instruction may be charging the user a fee to prematurely unlock their locked profile settings. In another example, in an emergency situation or rare market opportunity, a user may customize a message or select a preset message to type out by hand with the copy and paste feature disabled to deter the user from overriding the risk profile 302. In another example, the penalty instruction may include emailing an individual or entity, requiring a code, and so forth to unlock the rules. In another example, the rules may be unlocked without a penalty instruction when a processing device detects unusual market activity as defined by preset rules. The penalty instructions may be user set and determined so that a provider of the self-governing trade request management system may not be liable for preventing a user from sending a trade request to a trading broker or system.

In one embodiment, the user may select a risk profile 302 to be active for the defined amount of time for the risk profile duration indicator 208. In another embodiment, the user may select one or more settings for the risk rules 304, the psychological rules 306, and/or the physiological rules 308 and associate the settings with a new risk profile using the risk profile save button 310. As discussed above, the risk rules 304, the psychological rules 306, and/or the physiological rules 308 may include a variety of rules. In one embodiment, a field or graphical control element in the GUI 300 may be associated with each of the various rules such that the user may select which rules to enable/disable and/or different settings for one or more of the rules. For example, the field or graphical control element may include buttons, drop-down menus, radial buttons, list boxes, checkboxes, toggles, text field, and so forth that a user may use to set the rule associated with the field or graphical control element. The GUI 300 may enable a user to use a field or graphical control element associated with a rule to set an amount of time, an amount of money, a percentage amount, an amount with a unit associated with the rule, and so forth so that the user may build a custom or unique profile based on the user's desired profile. For example, the user may generate and save a profile that is customized and unique to the user so that the rules restrict the user's irrational, impulsive, and or undesirable trading habits and behavior. In another example, the risk profiles 302 may include predefined risk profiles with predefined rule settings for a user to select. In another embodiment, the GUI 300 may allow an input device to set a hierarchy of rule enforcement. For example, a user may use an input device to interact with the GUI 300 and drag and drop rules in a hierarchical ladder to set the priority of enforcement. The priority of enforcement may define whether one rule may override another rule based on the placement of the rule in the hierarchical ladder.

The disclosure above encompasses multiple distinct embodiments with independent utility. While these embodiments have been disclosed in a particular form, the specific embodiments disclosed and illustrated above are not to be considered in a limiting sense as numerous variations are possible. The subject matter of the embodiments includes the novel and non-obvious combinations and sub-combinations of the various elements, features, functions and/or properties disclosed above and inherent to those skilled in the art pertaining to such embodiments. Where the disclosure or subsequently filed claims recite “a” element, “a first” element, or any such equivalent term, the disclosure or claims is to be understood to incorporate one or more such elements, neither requiring nor excluding two or more such elements.

Applicant(s) reserves the right to submit claims directed to combinations and sub-combinations of the disclosed embodiments that are believed to be novel and non-obvious. Embodiments embodied in other combinations and sub-combinations of features, functions, elements and/or properties may be claimed through amendment of those claims or presentation of new claims in the present application or in a related application. Such amended or new claims, whether they are directed to the same embodiment or a different embodiment and whether they are different, broader, narrower or equal in scope to the original claims, are to be considered within the subject matter of the embodiments described herein.

1. A system, comprising:
a display configured to display a graphical user interface (GUI) to a user, the GUI executing on a first processing device;
an input device configured to interact with the GUI;
the first processing device coupled to the input device and the display, wherein the first processing device is configured to:
generate a trade rules account for the user based on trade rules account information received from the input device;
define a set of trade rules for one or more trade requests generated by the input device via the GUI;
receive a first user input from the input device, the first user input indicating a first trade rule of the set of trade rules associated with the trade rule account;
define a period of time that the first trade rule is enforced on the one or more trade requests by the user;
receive a first trade request from the input device via the GUI;
determine whether the first trade request follows the first trade rule; and
in response to the first trade request complying with the first trade rule, sending a first message to a second processing device, wherein the first message includes details of the first trade request; and
the second processing device communicatively coupled to the first processing device, wherein the second processing device is configured to, in response to receiving the first message:
execute a first trade order based on the details of the first trade request; and
send a second message to the first processing device indicating the execution of the first trade order.

2. The system of claim 1, wherein the first processing device is configured to in response to the first trade request being non-compliant with the first trade rule:
determine if an exception to the first trade rule applies;
in response to the exception not applying to the trade rule, reject the first trade request; and
display, by the display, a third message to the user indicating that the first trade request will not be completed during the period of time.

3. The system of claim 2, wherein the first processing device is configured to in response to the exception applying to the first trade rule, sending the first message to the second processing device.

4. The system of claim 2, wherein the exception is the first processing device receiving from the GUI an indication that the user overrode the first trade rule.

5. The system of claim 2, wherein the first processing device is configured to:
associate a penalty instruction with the exception; and
in response to the exception applying to the first trade rule, execute the penalty instruction.

6. The system of claim 5, wherein the penalty instruction is at least one of charging an account associated with the user a fee, requiring a preset type message be received from the input device, requiring the input device generate an email to send to a company and the first processing device sending the email to the company, or requiring a code be received from the input device.

7. The system of claim 5, wherein the penalty instruction is user-defined.

8. The system of claim 1, wherein the first processing device is further to:
receive a second trade request from the input device via the GUI;
determine whether the second trade request follows the first trade rule; and
in response to the second trade request being non-compliant with the first trade rule, rejecting the second trade request; and
display, by the display, a third message to the user indicating that the second trade request will not be completed during the period of time.

9. The system of claim 1, wherein the first processing device is configured to receive second user input from the input device, the second user input indicating a second trade rule of the set of trade rules associated with the trade rules account, wherein the first trade rule and the second trade rule are enforced on the one or more trade requests by the user during the period of time.

10. The system of claim 9, wherein the first trade rule is a first type of rule that is one of a risk rule, a psychological rule, or a physiological rule and the second trade rule is a second type of rule that is one of the risk rule, the psychological rule, or the physiological rule, wherein:
the risk rule is a session filter rule, a trend rule, a correlation guard rule, a stop widen guard rule, a max daily loss rule, a max order size rule, a max orders open rule, a max total orders rule, a preset probability sizes rule, a trade setup quality rule, a volatility sizing rule, a smart exits rule, a smart stops rule, a hedge all positions rule, a breakeven stop loss rule, a multiple scenario entry rule, an add to winners rule, an event guard rule, an max overnight or overweekend size rule, or a value at risk (VaR) sizing rule;
the psychological rule is a profitable streak day filter rule, a profitable streak profit keeper rule, a loser's average rule, a chase or fear of missing out (FOMO) Guard rule, a revenge trading guard rule, a patience rule, an emotion guard rule; and
the physiological rule is a fat finger guard rule, a biometric signals rule, or a trader nap rule.

11. The system of claim 10, wherein the first trade rule is the risk rule and the second trade rule is the psychological rule or the physiological rule.

12. The system of claim 1, wherein the first processing device is configured to associate a rule profile with two or more trade rules, wherein the two or more trade rules include the first trade rule.

14. The system of claim 1, wherein the first processing device is a first device associated with the user and the second processing device is a second device associated with a brokerage firm.

15. A method, comprising:
generating, by a first processing device, a trade rules account for a user based on trade rules account information received from an input device;
defining, by the first processing device, a set of trade rules for one or more trade requests generated by the input device;
receiving, by the first processing device, a first user input from the input device, the first user input indicating a first trade rule of the set of trade rules associated with the trade rule account;
defining a period of time that the first trade rule is enforced on the one or more trade requests by the user;
receiving a first trade request from the input device;
determining whether the first trade request follows the first trade rule; and
in response to the first trade request complying with the first trade rule, sending a first message to a second processing device, wherein the first message includes details of the first trade request.

16. The method of claim 15, further comprising:
executing, by the second processing device, a first trade order based on the details of the first trade request; and
sending, by the second processing device, a second message to the first processing device indicating the execution of the first trade order.

17. The method of claim 15, further comprising receiving a second user input from the input device, the second user input indicating a second trade rule of the set of trade rules associated with the trade rule account, wherein:
the first trade rule and the second trade rule are enforced on the one or more trade requests by the user during the period of time;
the first trade rule is a first type of rule that is one of a risk rule, a psychological rule, or a physiological rule and the second trade rule is a second type of rule that is one of the risk rule, the psychological rule, or the physiological rule;
the risk rule is a session filter rule, a trend rule, a correlation guard rule, a stop widen guard rule, a max daily loss rule, a max order size rule, a max orders open rule, a max total orders rule, a preset probability sizes rule, a trade setup quality rule, a volatility sizing rule, a smart exits rule, a smart stop rule, a hedge all positions rule, a breakeven stop loss rule, a multiple scenario entry rule, an add to winners rule, event guard rule, max overnight or overweekend size rule, or a value at risk (VaR) sizing rule;
the psychological rule is a profitable streak day filter rule, a profitable streak profit keeper rule, a loser's average rule, a chase or fear of missing out (FOMO) Guard rule, a revenge trading guard rule, a patience rule, an emotion guard rule; and
the physiological rule is a fat finger guard rule, a biometric signals rule, or a trader nap rule.

18. An apparatus, comprising:
a display configured to display a graphical user interface (GUI) to a user, the GUI executing on a first processing device;
an input device configured to interact with the GUI;
the first processing device coupled to the input device and the display, wherein the first processing device is configured to:
generate a trade rules account for the user based on trade rules account information received from the input device;
define a set of trade rules for one or more trade requests generated by the input device via the GUI;
receive a user input from the input device, the user input indicating a trade rule of the set of trade rules associated with the trade rule account;
define a period of time that the trade rule is enforced on the one or more trade requests by the user;
receive a trade request from the input device via the GUI;
determine whether the trade request follows the trade rule; and
in response to the trade request complying with the trade rule, sending a first message to a second processing device, wherein the first message includes details of the trade request.

19. The apparatus of claim 18, further comprising the second processing device communicatively coupled to the first processing device, wherein the second processing device is configured to execute a trade order based on the details of the trade request.

20. The apparatus of claim 18, wherein the trade rule is a risk rule, psychological rule, or a physiological rule.
